(19) United States
(12) Patent Application Publication
(10) Pub. No.: US 2026/0333097 A1
(43) Pub. Date: Oct. 22, 2026

(54) SIGNAL-TO-INTERFERENCE PLUS NOISE RATIO PREDICTION

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Taesang YOO, San Diego, CA (US)

(21) Appl. No.: 19/186,469

(22) Filed: Apr. 22, 2025

(51) Int. Cl. H04W 24/10; H04L 5/00

(52) U.S. Cl. CPC H04W 24/10; H04L 5/0048

(57) ABSTRACT

Certain aspects of the present disclosure provide techniques for wireless communications. An example method includes transmitting a configuration indicating a set of resources comprising a set of measurement resources and a set of prediction resources; and receiving a report comprising one or more signal-to-noise and interference ratio (SINR) values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

### INTRODUCTION

### Field of the Disclosure

Aspects of the present disclosure relate to wireless communications, and more particularly, to techniques for predicting a signal-to-interference plus noise ratio (SINR).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a network entity. The method includes transmitting a configuration indicating a set of resources comprising a set of measurement resources and a set of prediction resources; and receiving a report comprising one or more signal-to-noise and interference ratio (SINR) values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

Certain aspects provide a method for wireless communications by a user equipment (UE). The method includes receiving, from a network entity, a configuration indicating a set of resources comprising a set of measurement resources and a set of prediction resources; and transmitting, to the network entity, a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communications channel between a network entity and a UE.

FIG. 6 depicts an example artificial intelligence (AI) architecture that may be used for AI-enhanced wireless communications.

FIG. 7 depicts an example AI architecture of a first wireless device that is in communication with a second wireless device.

FIG. 8 depicts an example artificial neural network.

FIG. 9 depicts an example of signal-to-interference plus noise ratio (SINR) prediction.

FIG. 10 depicts examples of measurement resources and prediction resources associated with SINR prediction.

FIG. 11 depicts a process flow for communications in a network between a network entity and a UE.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for predicting a signal-to-interference plus noise ratio (SINR).

In certain wireless communications systems, such as 5G New Radio (NR) systems and/or future wireless communications technologies, closed-loop feedback associated with a communications channel may be used to dynamically adapt communications link parameters (e.g., modulation and coding scheme, beamforming, MIMO layers, etc.) according to time varying channel conditions, for example, due to changes with respect to UE mobility, weather conditions, scattering, fading, interference, noise, etc. A UE may provide a CSI report (which may be referred to as a channel state feedback (CSF) or CSI feedback, or the CSI included in which may be referred to as a CSF) to a network entity (e.g., a base station), which may adjust certain communications link parameters in response to the CSF from the UE. The CSI report includes CSI (e.g., determined by the UE). For example, the CSI includes layer indicator, rank indicator, etc. The CSI is based on a channel matrix that is derived from measuring the channel. Link adaptation (such as adaptive modulation and coding) with various modulation schemes and channel coding rates may be applied to certain communications channels.

As an example, a UE may measure a reference signal and estimate the channel state based on measurements of that reference signal. The UE may report an estimated channel state to the network entity in the form of CSF. In certain cases, the CSF may indicate channel properties of a communications link between the network entity and the UE. For example, the CSF may indicate the effect of, for example, scattering, fading, and pathloss of a signal propagating across the communications link. In some cases, the CSF may indicate the UE's preferred precoding for MIMO and/or beamformed communications, for example, in the form of a precoding feedback (e.g., a precoding matrix indicator (PMI)). As an example, the CSF (e.g., a CSI report) may include a channel quality indicator (CQI), PMI, a layer indicator (LI), a rank indicator (RI), a reference signal received power (RSRP), a signal-to-interference-plus-noise ratio (SINR), etc. Additional or other information may be included in the CSF.

An SINR is a measurement of a signal quality. The SINR may be defined as a ratio between a received signal power (e.g., including a channel power) and a sum of an interference power and a noise power. SINR variations significantly impact communications performance. Moreover, there is typically a delay between SINR measurements (e.g., reported by a UE) and actual use of these measurements in scheduling communications for the UE. This delay creates a mismatch that can affect the communications performance, for example, as the SINR may fluctuate during the delay. In some cases, SINR prediction (e.g., in time and/or space) can address this mismatch. However, certain technical challenges exist for SINR prediction.

The technical challenges for SINR prediction may include, for example, many factors that affect channel and interference patterns observed at a specific UE. For example, these factors may result in channel and interference variations (e.g., channel power variations and interference power variations) that make it technically challenging to predict an SINR that can be used for scheduling communications for a UE. For example, the channel and interference variations make it difficult to drive, for example, an analytical model to predict the SINR. In certain cases, interference variations may be more significant compared to channel variations, while in some other cases, the channel variations may be more significant compared to the interference variations. The variations may be over time, beams, and/or frequency (e.g., sub-channels).

In certain cases, the SINR prediction may be implemented, for example, by utilizing an artificial intelligence or machine learning (AI/ML)-based solution. The AI/ML-based solution for SINR prediction may include learning interference and channel variation patterns (e.g., interference and channel measurements) from certain resources, such as previous resources, to enable SINR predictions (e.g., including or based on interference and/or channel predictions) on other resources, such as future resources. The SINR prediction (e.g., using the AI/ML-based solution) may enable improved wireless communications performance, such as reduced reporting overhead and reduced power consumption (e.g., for a UE). The reduced reporting overhead and reduced power consumption may be attributable to reduced amount of SINR measurement and increased UE sleep time, for example, where the increased UE sleep time may be due to the reduced amount of SINR measurement (e.g., reduced measurement duration).

Aspects described herein may overcome the aforementioned technical challenges (e.g., attributable to the channel and interference variations) by providing a solution for configuring varied numbers of measurement and prediction resources for the SINR prediction, for example, based on the observed channel and interference variations. In some aspects, a UE may be configured to perform SINR prediction based on more interference measurements compared to channel measurements when interference variations are more significant compared to channel variations. For example, the UE may be configured to perform more channel predictions compared to interference predictions. In some cases, the UE may be configured to perform only channel predictions (and no interference predictions, where no interference prediction resources may be configured). In some aspects, a UE may be configured to perform SINR prediction based on more channel measurements compared to interference measurements when channel variations are more significant compared to interference variations. For example, the UE may be configured to perform more interference predictions compared to channel predictions. In some cases, the UE may be configured to perform only interference predictions (and no channel predictions, where no channel prediction resources may be configured).

This solution provides the beneficial technical advantage of a flexibility in configuring a UE to report one or more predicted SINRs. For example, a UE may be configured to report one or more predicted SINRs based on channel prediction only, interference prediction only, or both channel and interference predictions. In certain cases, a prediction (e.g., a channel prediction or an interference prediction) based on more measurements (e.g., compared to when based on less measurements) may result in increased accuracy in the prediction, since the prediction would be based on more of measurement data. In certain cases, a prediction (e.g., a channel prediction or an interference prediction) based on less measurements (e.g., compared to when based on more measurements) may result in reduced reporting overhead and/or reduced power consumption, since a UE and a network entity may communicate less of measurement data.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

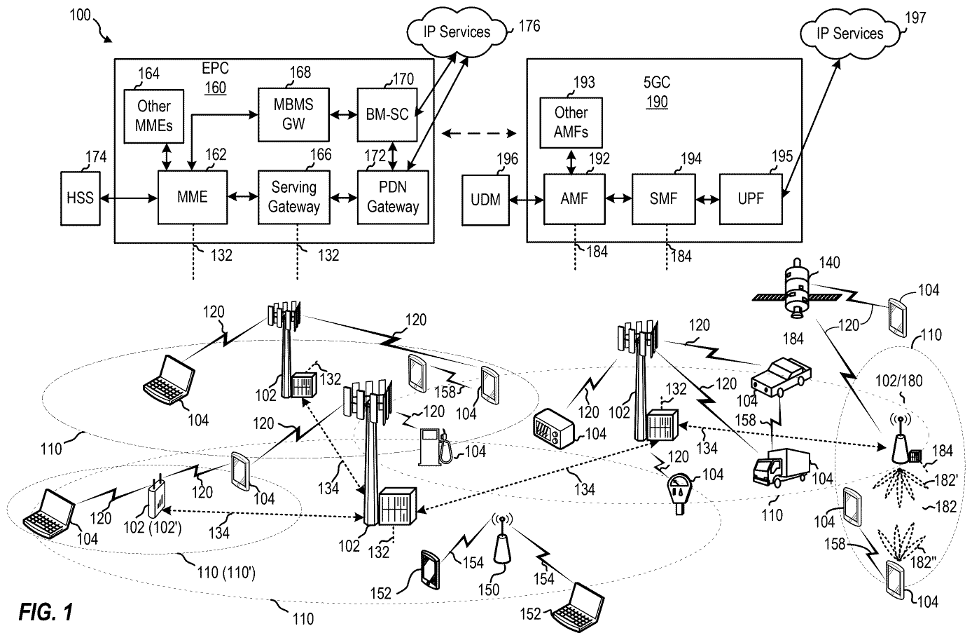

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

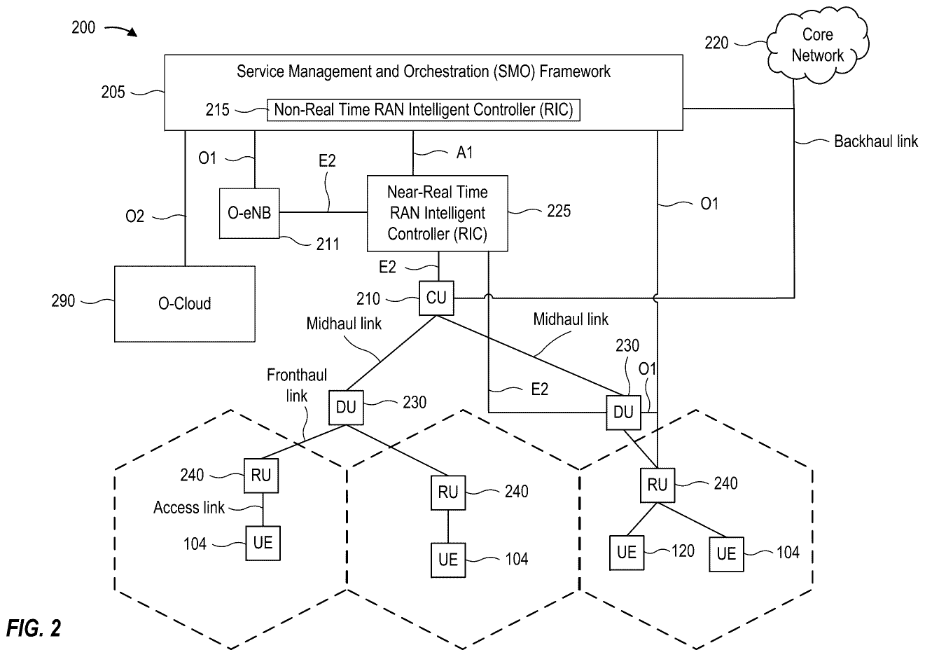

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

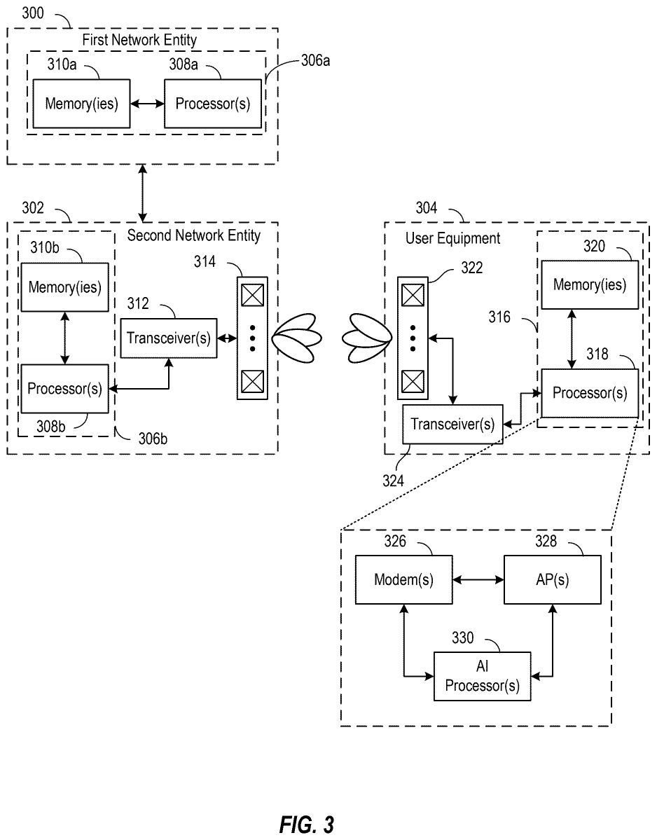

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGA s), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

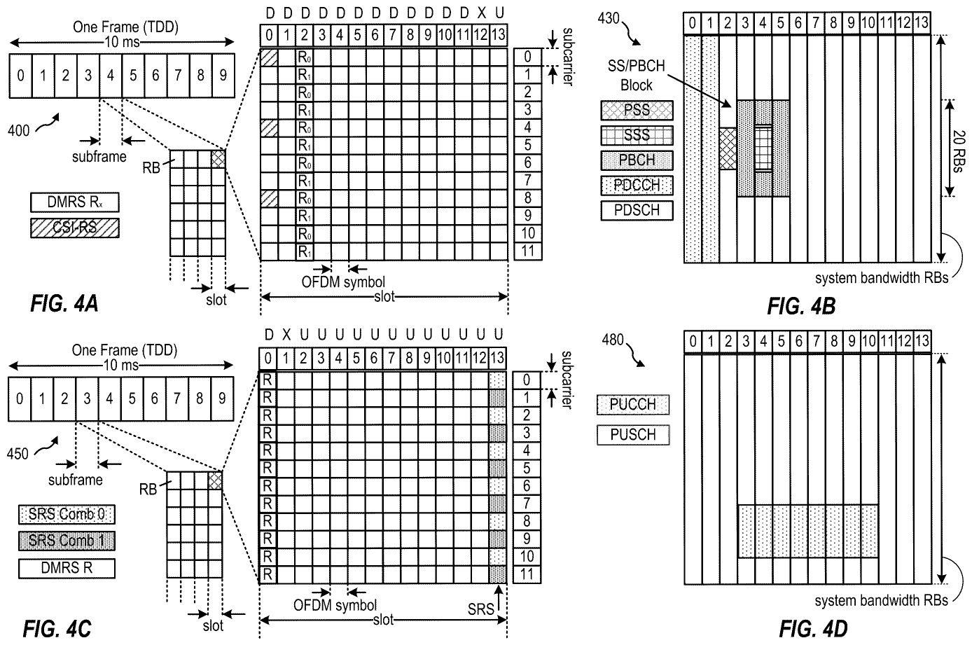

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communications systems, closed-loop feedback associated with a communications channel may be used to dynamically adapt communications link parameters to channel conditions that may change over time. In some cases, a UE may receive a reference signal (e.g., SSB, CSI-RS, DM-RS, etc.) from a network entity (or another UE) and report channel state feedback to the network entity (or the other UE), where the channel state feedback is determined based on measurements of the reference signal received at the UE (e.g., including SINR measurements described herein). In certain cases, a UE may transmit a reference signal (e.g., SSB, CSI-RS, DM-RS, PT-RS, SRS, etc.), and a network entity (or another UE) may determine characteristics associated with the channel based on measurements of the received reference signal.

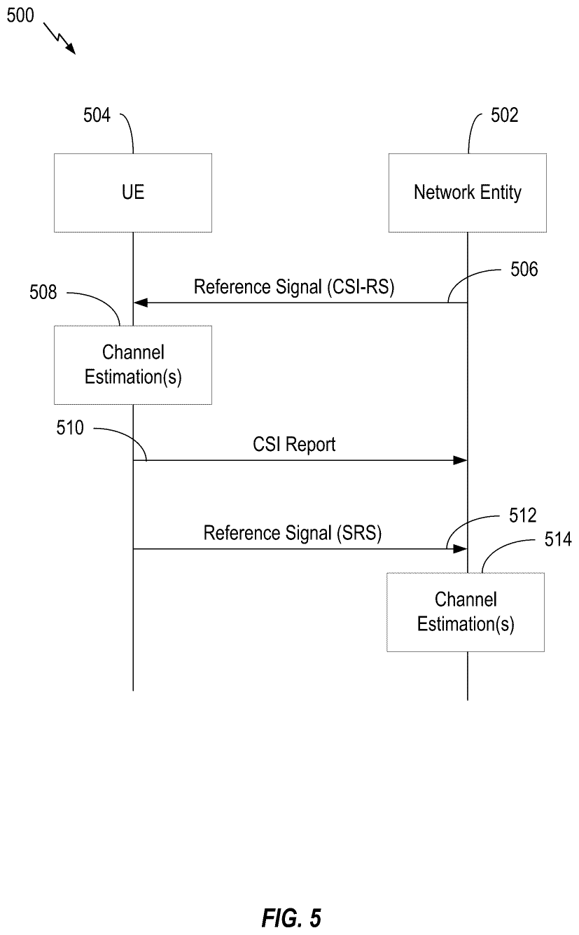

FIG. 5 depicts a process flow 500 for closed-loop feedback associated with a communications channel between a network entity 502 and a UE 504.

At 506, the UE 504 receives a reference signal (e.g., SSB, CSI-RS, etc.) from the network entity 502.

At 508, the UE 504 performs channel calculations based on the reference signal, such as determining a channel estimate H based on the received reference signal. For example, the UE 504 may include a demodulator, which may be part of a transceiver (e.g., transceiver 354 of FIG. 3), RX MIMO detector (e.g., RX MIMO detector 356 of FIG. 3), and/or receive processor (e.g., receive processor 358 of FIG. 3) of UE 504. The demodulator, such as a component of the demodulator, may take as input the reference signal as received over multiple antennas of the UE 504 and output a vector y that is a representation of the received reference signal as received over each of the multiple antennas of the UE 504.

Based on a received signal model, the vector y can be represented as follows in equation (1):

\vec{y}=H\vec{x}+\vec{n} (1)

In equation (1), H corresponds to a matrix representation of the communications channel, as in a channel estimate of the communications channel the signal is communicated in (e.g., downlink communications channel where the reference signal is communicated), \vec{x} is the vector representing symbols transmitted by network entity 502 over a number of spatial layers, and \vec{n} is noise across the communications channel. In certain aspects, H has a size equal to the number of antennas used to receive the signaling, Nₐₙₜ, times the number of spatial layers, N_{I}, (e.g., the number of beamformed transmissions, number of antenna ports, etc.). For example, H has a number of rows equal to Nₐₙₜ and a number of columns equal to N_{I}. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[USV], such that SVD provides the precoder V. U may be related to the ordering of the rows of H, as in the ordering of the antennas as represented by H. It should be understood that other suitable techniques may be used to determine the precoder V based on the channel estimate H.

At 510, UE 504 sends to network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for the downlink transmissions on the PDSCH. CQI may be an indicator of channel quality, such as corresponding to H. The UE 504 may send an indication of the one or more determined CSI parameters to the network entity 502 in the CSI report. The network entity 502 may schedule downlink data transmissions to the UE 504 accordingly, such as using a modulation scheme, code rate, number of transmission layers, etc., that the network entity determines based on the CSI report.

At 512, UE 504 sends a reference signal (e.g., SSB, CSI-RS, DM-RS, PT-RS, SRS, etc.) to the network entity 502.

At 514, the network entity 502 performs channel calculations based on the reference signal, such as determining a channel estimate H based on the received reference signal, for example, as described herein with respect to the UE performing channel calculations at 508.

In certain aspects, network entity 502 may further calculate, as part of the channel calculations, a precoder (e.g., precoder matrix) V based on the channel estimate H, for example, as described herein with respect to the UE 504 performing such a calculation. Accordingly, the network entity 502 may determine H and/or V for an uplink channel between UE 504 and network entity 502 based on SRS. Further, as discussed, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

Note that FIG. 5 generally relates to CSI determination and reporting. However, some techniques described with respect to FIG. 5, such as configuration of measurement resources and reporting of measurements or a report derived from measurements on the resources, can be applied in the context of SINR measurement and/or prediction, as described below.

### Example Artificial Intelligence for Wireless Communications

Certain aspects described herein may be implemented, at least in part, using some form of artificial intelligence (AI), e.g., the process of using a machine learning (ML) model to infer or predict output data based on input data. For example, the SINR prediction described herein may be implemented, at least in part, using one or more ML models (which may also be referred to as AI/ML models). An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

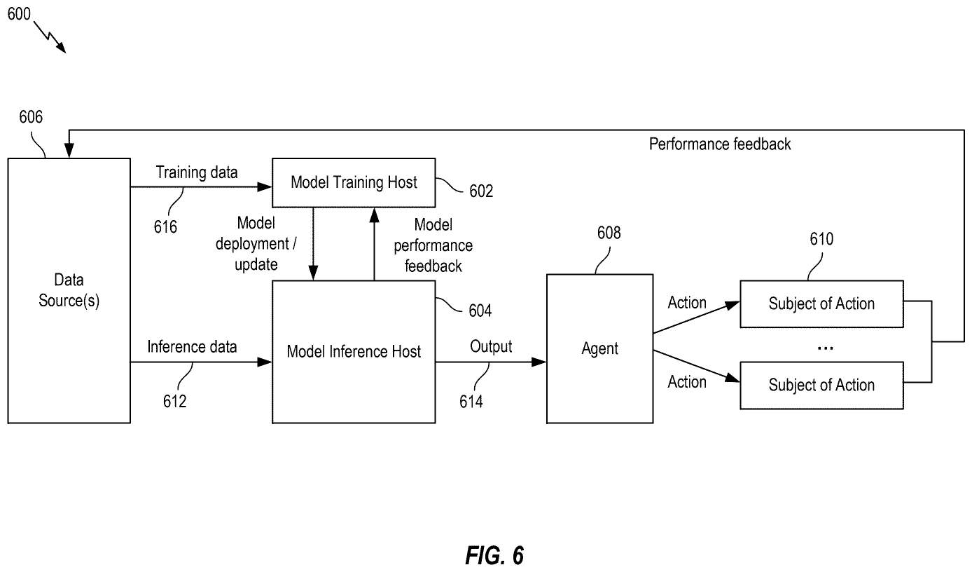

FIG. 6 is a diagram illustrating an example AI architecture 600 that may be used for AI-enhanced wireless communications. As illustrated, the architecture 600 includes multiple logical entities, such as a model training host 602, a model inference host 604, data source(s) 606, and an agent 608. The AI architecture may be used in any of various use cases for wireless communications, such as those listed above.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608. In certain aspects, the model inference host 604 may be an example of a model inference agent.

The agent 608 may be an element or an entity of a wireless communication system including, for example, a radio access network (RAN), a wireless local area network, a device-to-device (D2D) communications system, etc. that utilize a range of UEs and/or network entities as described herein with reference to FIGS. 1, 2, 3, 4A, 4B, 4C, and 4D. In certain examples, the agent 608 may be an example of a decision agent. In some examples, the agent 608 may be a UE, a base station, or any disaggregated network entity thereof including a CU, a DU, and/or an RU, an access point, a wireless station, a RIC in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with beam management, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, if agent 608 is a DU or an RU and the output from model inference host 604 is associated with beam management, the agent 608 may determine whether to change or modify a transmit and/or receive beam based on the output 614. If the agent 608 determines to act based on the output 614, agent 608 may indicate the action to at least one subject of the action 610. For example, if the agent 608 determines to change or modify a transmit and/or receive beam for a communication between the agent 608 and the subject of action 610 (e.g., a UE), the agent 608 may send a beam switching indication to the subject of action 610 (e.g., a UE). As another example, the agent 608 may be a UE, the output 614 from model inference host 604 may be one or more predicted channel characteristics for one or more beams. For example, the model inference host 604 may predict channel characteristics for a set of beams based on the measurements of another set of beams. Based on the predicted channel characteristics, the agent 608, such as the UE, may send, to the subject of action 610, such as a BS, a request to switch to a different beam for communications. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a beam configuration from agent 608, the subject of action 610 may provide performance feedback associated with the beam configuration to the data sources 606, where the performance feedback may be used by the model training host 602 for monitoring and/or evaluating the ML model performance, such as whether the output 614, provided to agent 608, is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, an ML model is deployed at or on a UE for SINR prediction. More specifically, a model inference host, such as model inference host 604 in FIG. 6, may be deployed at or on the UE for SINR prediction. Alternatively, the ML model may be deployed at an ML server associated with the UE.

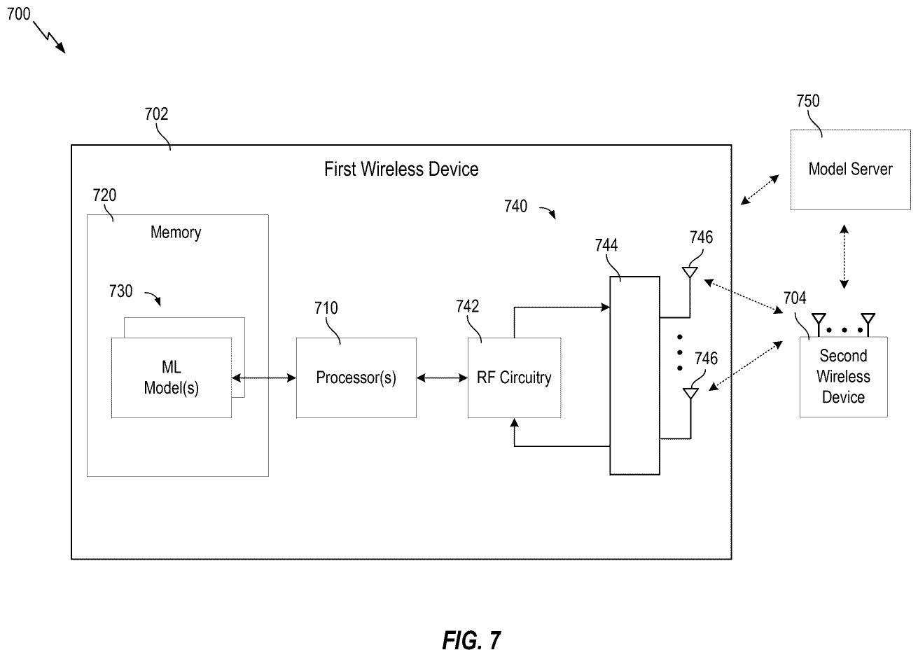

FIG. 7 illustrates an example AI architecture 700 of a first wireless device 702 that is in communication with a second wireless device 704. The first wireless device 702 may be a UE as described herein with respect to FIG. 1-3. Similarly, the second wireless device 704 may be a network entity or a network node as described herein with respect to FIG. 1-3. Note that the AI architecture of the first wireless device 702 may be applied to the second wireless device 704.

The first wireless device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a transmit mode, the processor 710 may transform information (e.g., packets or data blocks) into modulated symbols. As digital baseband signals (e.g., digital in-phase (I) and/or quadrature (Q) baseband signals representative of the respective symbols), the processor 710 may output the modulated symbols to a transceiver 740. The processor 710 may be coupled to the transceiver 740 for transmitting and/or receiving signals via one or more antennas 746. In this example, the transceiver 740 includes radio frequency (RF) circuitry 742, which may be coupled to the antennas 746 via an interface 744. As an example, the interface 744 may include a switch, a duplexer, a diplexer, a multiplexer, and/or the like. The RF circuitry 742 may convert the digital signals to analog baseband signals, for example, using a digital-to-analog converter. The RF circuitry 742 may include any of various circuitry, including, for example, baseband filter(s), mixer(s), frequency synthesizer(s), power amplifier(s), and/or low noise amplifier(s). In some cases, the RF circuitry 742 may upconvert the baseband signals to one or more carrier frequencies for transmission. The antennas 746 may emit RF signals, which may be received at the second wireless device 704.

In receive mode, RF signals received via the antenna 746 (e.g., from the second wireless device 704) may be amplified and converted to a baseband frequency (e.g., downconverted). The received baseband signals may be filtered and converted to digital I or Q signals for digital signal processing. The processor 710 may receive the digital I or Q signals and further process the digital signals, for example, demodulating the digital signals.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take measurements of a reference signal (e.g., corresponding to a wide beam) as input to predict a channel characteristic associated with a different reference signal (e.g., corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), an SINR, a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, the one or more reference or pilot signals for which the one or more measurements are predicted may be considered “virtual resources” in they are not actually transmitted, but the measurements are predicted as though they were transmitted. In certain aspects, the one or more reference or pilot signals for which the one or more measurements are predicted may actually be transmitted but not actually measured by first wireless device 702. Note that other input data and/or output data may be used in addition to or instead of the examples described herein.

In certain aspects, a model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 to collect and host training data, inference data, and/or performance feedback associated with an ML model 730. In certain aspects, the model server 750 may host various types and/or versions of the ML models 730 for the first wireless device 702 and/or the second wireless device 704 to download.

In some cases, the model server 750 may monitor and evaluate the performance of the ML model 730 to trigger one or more LCM tasks. For example, the model server 750 may determine whether to activate or deactivate the use of a particular ML model at the first wireless device 702 and/or the second wireless device 704, and the model server 750 may provide such an instruction to the respective first wireless device 702 and/or the second wireless device 704. In some cases, the model server 750 may determine whether to switch to a different ML model 730 being used at the first wireless device 702 and/or the second wireless device 704, and the model server 750 may provide such an instruction to the respective first wireless device 702 and/or the second wireless device 704. In yet further examples, the model server 750 may also act as a central server for decentralized machine learning tasks, such as federated learning.

### Example Artificial Intelligence Model

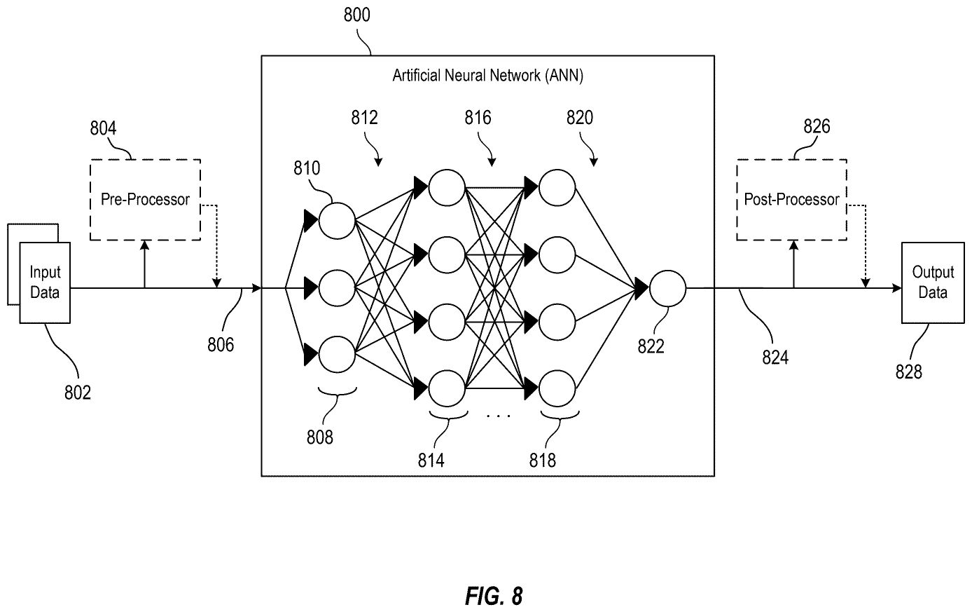

FIG. 8 is an illustrative block diagram of an example artificial neural network (ANN) 800.

ANN 800 may receive input data 806 which may include one or more bits of data 802, pre-processed data output from pre-processor 804 (optional), or some combination thereof. Here, data 802 may include training data, verification data, application-related data, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 606 in FIG. 6). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc. Once an initial model has been designed, training of the model may be conducted using training data. Training data may include one or more datasets within which ANN 800 may detect, determine, identify or ascertain patterns. Training data may represent various types of information, including written, visual, audio, environmental context, operational properties, etc. During training, parameters of artificial neurons 810 may be changed, such as to minimize or otherwise reduce a loss function or a cost function. A training process may be repeated multiple times to fine-tune ANN 800 with each iteration.

Various ANN model structures are available for consideration. For example, in a feedforward ANN structure each artificial neuron 810 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 800 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGA s), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 800 of FIG. 8.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 800 of FIG. 8, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Aspects Related to Signal-to-Interference Plus Noise Ratio Prediction

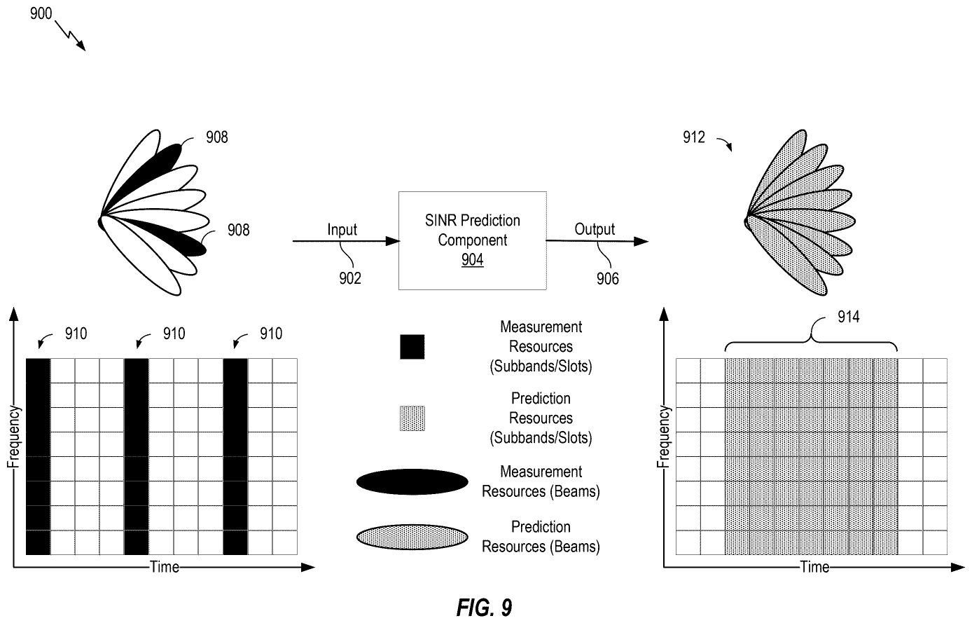

FIG. 9 depicts an example 900 of SINR prediction. In the depicted example 900, an input 902 is provided to an SINR prediction component 904, and the SINR prediction component 904 generates an output 906 based on the input 902. For example, channel and/or interference measurements on a set of resources (e.g., a set of previous resources or a subset of the set of previous resources) are utilized as the input 902 to the SINR prediction component 904 to generate (e.g., predict) the output 906. The output 906 may include one or more SINR values on one or more resources of a set of resources (e.g., a set of future resources or a subset of the set of future resources). An SINR (SINR) is a ratio between a received signal power (e.g., including a channel power, S) and a sum of an interference power (I) and a noise power (N), where

$$S I N R = \frac{S}{I + N} .$$

Thus, the SINR may be determined (or predicted) based on the channel power, the interference power, and/or the noise power. In certain aspects, the channel power may be referred to as a channel power component or a channel component, and the interference power may be referred to as an interference power component or an interference component.

In certain aspects, the set of measurement resources and the set of prediction resources may vary in time (e.g., where the resources correspond to slots), space (e.g., where the resources correspond to beams), and/or frequency (e.g., where the resources correspond to subbands). In the depicted example 900, the input 902 includes measurement resources that correspond to measurement beams 908 and measurement subbands/slots 910 (which in some cases may be more generally referred to as time and frequency resources, where a subband may be an example of a frequency resource, and a slot may be an example of a time resource). Measurement beams 908 include beams with channel and interference measurements, and measurement subbands/slots 910 include subbands/slots with channel and interference measurements. Moreover, the output 906 includes prediction resources that correspond to prediction beams 912 and prediction subbands/slots 914. Prediction beams 912 include beams with predicted SINRs, and prediction subbands/slots 914 include subbands/slots with predicted SINRs. For example, the measurement resources may correspond to previous resources used to generate or predict the prediction resources which may correspond to future resources.

In certain aspects, the SINR prediction component 904 may implement an algorithm using, for example, a deep neural network (e.g., an RNN, a convolutional neural network (CNN), a transformer, etc.), an ML model (e.g., a support vector machine (SVM) model, a random forest model, a k-nearest neighbors (KNN) model, etc.), an autoregressive approach, a minimum mean square error (MMSE) predictor approach, and/or others.

In certain cases, a CSI report (e.g., described herein with reference to FIG. 5) may be enhanced via beam prediction (e.g., an AI-based beam prediction). Such Ai-based beam prediction may increase beam prediction accuracy, which in turn may enable higher throughput and energy saving performance. In some cases, such throughput and energy saving performance may be further enhanced via SINR prediction described herein. Interference (used for determining an SINR) has different characteristics than channel. For example, an interference variation may be larger than a channel variation in some cases. Efficient interference prediction and adaptation may enable advanced scheduling techniques that can enhance an overall throughput of a communications system. Predicting an SINR and reporting the predicted SINR account for both channel characteristics and interference conditions. Accordingly, predicting the SINR and reporting the predicted SINR may enhance beam management as well as scheduling performance.

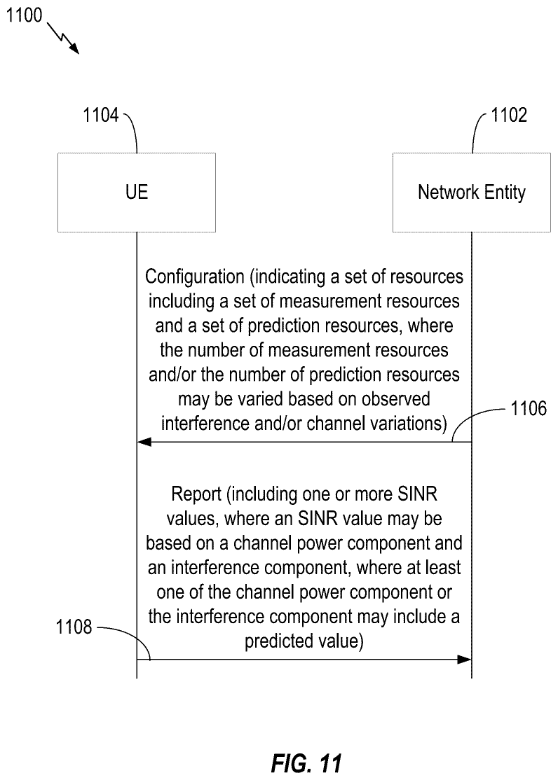

In certain cases, an SINR measurement may be based on one or more resource settings (which may also be referred to as resource configurations) including a configuration of one or more resources for the SINR measurement. When one resource setting is configured, the resource setting may be for channel and interference measurement on non-zero power (NZP) CSI-RS for Layer 1 (L1)-SINR computation. For example, a UE may use the same 1-port NZP CSI-RS resource(s) with density 3 REs/RB for channel and interference measurement. When two resource settings are configured, the first resource setting may be for channel measurement, and the second resource setting may be for interference measurement. When three resource settings are configured, the first resource setting may be for channel measurement, the second resource setting may be for interference measurement (e.g., CSI-interference measurement (IM)-based interference measurement), and the third resource setting may be for NZP CSI-RS interference measurement. In certain aspects, similar settings may be used, as part of one or more modes of configuration, for SINR prediction as described further herein, for example, with reference to FIG. 11.

In certain aspects, SINR prediction may be based on a first mode based on channel prediction and interference prediction. In certain aspects, SINR prediction may be based on a second mode based on channel measurement and interference prediction. In certain aspects, SINR prediction may be based on a third mode based on channel prediction and interference measurement. For example, for the first mode, a UE may utilize an SINR prediction AI/ML model, or a channel power prediction AI/ML model and an interference power prediction AI/ML model. For the second mode, the UE may utilize an interference power prediction AI/ML model. For the third mode, the UE may utilize a channel power prediction AI/ML model. In certain aspects, the SINR prediction AI/ML model, the channel power prediction AI/ML model, and the interference power prediction AI/ML model may be implemented using one or more components of an AI/ML model, described herein with reference to FIGS. 6-8, where the SINR prediction AI/ML model, the channel power prediction AI/ML model, and the interference power prediction AI/ML model may be implemented to predict, respectively, an SINR, a channel power, and an interference power. In the first mode, the SINR prediction may be based on an SINR prediction by the SINR prediction AI/ML model, or a channel power prediction and an interference power prediction, separately performed using a channel power prediction AI/ML model and an interference power prediction AI/ML model. In the second mode, the SINR prediction may be based on a channel power measurement and an interference power prediction (performed using an interference power prediction AI/ML model). In the third mode, the SINR prediction may be based on a channel power prediction (performed using a channel power prediction AI/ML model) and an interference power measurement.

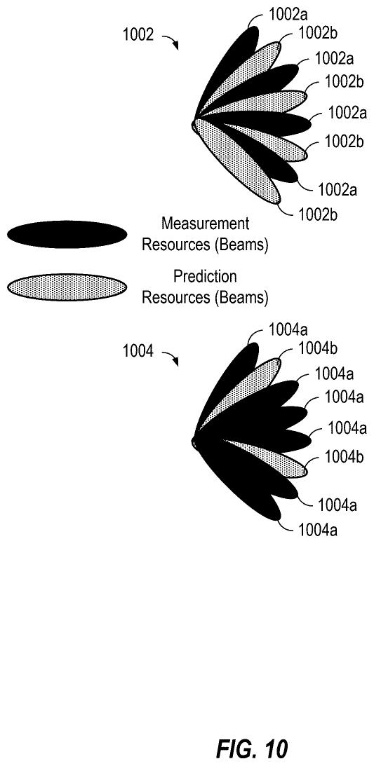

FIG. 10 depicts examples 1002 and 1004 of measurement resources (e.g., measurement beams, and which may be referred to as “Set-B resources” or “Set-B beams”) and prediction resources (e.g., prediction beams, and which may be referred to as “Set-A resources” or “Set-A beams”) associated with SINR prediction. Example 1002 depicts a set of channel measurement resources (beams) 1002a (which may be referred to as “Set-B1 resources” or “Set-B1 beams”) and a set of channel prediction resources (beams) 1002b (which may be referred to as “Set-A1 resources or “Set-A1 beams”). Example 1004 depicts a set of interference measurement resources (beams) 1004a (which may be referred to as “Set-B2 resources” or “Set-B2 beams”) and a set of interference prediction resources (beams) 1004b (which may be referred to as “Set-A2 resources” or “Set-A2 beams”). In certain aspects, a UE may obtain or receive a configuration for SINR prediction, where the configuration may include a set of measurement resources and a set of prediction resources. In some aspects, the set of measurement resources may include a set of channel measurement resources and a set of interference measurement resources, and the set of prediction resources may include a set of channel prediction resources and/or a set of interference prediction resources. These resources may vary in time, frequency, and/or space.

In certain aspects, such as when interference variations are more significant compared to channel variations, a UE may be configured with SINR prediction based on more interference measurements (e.g., on more interference measurement resources) compared to channel measurements (e.g., on channel measurement resources). For example, the SINR prediction may be based on more channel predictions (e.g., on more channel prediction resources) compared to interference predictions (e.g., on interference prediction resources). Thus, the UE may be configured with more interference measurement resources (compared to channel measurement resources) and more channel prediction resources (compared to interference prediction resources). This example is depicted in FIG. 10, where a number of the channel prediction resources 1002b is higher than a number of the interference prediction resources 1004b, and a number of the interference measurement resources 1004a is higher than a number of the channel measurement resources 1002a.

In certain aspects, such as when channel variations are more significant compared to interference variations, a UE may be configured with SINR prediction based on more channel measurements (e.g., on more channel measurement resources) compared to interference measurements (e.g., on more interference measurement resources). For example, the SINR prediction may be based on more interference predictions (e.g., on more interference prediction resources) compared to channel predictions (e.g., on channel prediction resources). Thus, the UE may be configured with more channel measurement resources (compared to interference measurement resources) and more interference prediction resources (compared to channel prediction resources). Generally, configuring more measurement resources may increase the accuracy of prediction (e.g., channel power prediction or interference power prediction). Alternatively, configuring more prediction resources (e.g., less measurement resources) may reduce the reporting overhead (e.g., for the UE to report measurements) and power consumption (e.g., for monitoring reference signals). The examples described above with reference to FIG. 10 may generally correspond to the first mode of SINR prediction based on channel prediction and interference prediction. In certain cases, a UE may be configured with no channel prediction resources, which may correspond to the second mode of SINR prediction based on channel measurement and interference prediction. In some cases, a UE may be configured with no interference prediction resources, which may correspond to the third mode of SINR prediction based on channel prediction and interference measurement. In certain cases, a single resource (e.g., SSB or CSI-RS) may be used as a channel and interference measurement resource. For example, both channel measurement and interference measurement may be performed on this same resource.

### Example Signaling of Signal-to-Interference Plus Noise Ratio Prediction

FIG. 11 depicts a process flow 1100 for communications in a network between a network entity 1102 and a user equipment (UE) 1104. In some aspects, the network entity 1102 may be an example of the BS 102 depicted and described with respect to FIG. 1 the first network entity 300 or the second network entity 302 depicted and described with respect to FIG. 3, a disaggregated base station depicted and described with respect to FIG. 2 or the network entity 502 depicted and described with respect to FIG. 5. Similarly, the UE 1104 may be an example of UE 104 depicted and described with respect to FIG. 1 the UE 304 depicted and described with respect to FIG. 3, or the UE 504 depicted and described with respect to FIG. 5. However, in other aspects, UE 1104 may be another type of wireless communications device and network entity 1102 may be another type of network entity or network node, such as those described herein. Note that any operations or signaling illustrated with dashed lines may indicate that that operation or signaling is an optional or alternative example.

At 1106, network entity 1102 transmits a configuration indicating a set of resources including a set of measurement resources (e.g., Set-B resources, such as Set-B1 and/or Set-B2 resources, described above with reference to FIG. 10) and a set of prediction resources (e.g., Set-A resources, such as Set-A1 and/or Set-A2 resources, described above with reference to FIG. 10). In certain aspects, the network entity 1102 may transmit the configuration via RRC signaling, or activate or deactivate the configuration as part of a MAC-CE or as part of a DCI.

In certain aspects, the set of measurement resources may include a set of channel measurement resources and a set of interference measurement resources, and the set of prediction resources may include at least one of a set of channel prediction resources or a set of interference prediction resources, as described herein with reference to FIG. 9. In some cases, the set of interference measurement resources may include a set of zero power interference measurement resources (which may be referred to as “Set-B2 resources”) and a set of non-zero power interference measurement resources (which may be referred to as “Set-B3 resources”), and the set of interference prediction resources may include a set of zero power interference prediction resources (which may be referred to as “Set-A2 resources”) and a set of non-zero power interference prediction resources (which may be referred to as “Set-A3 resources”). For example, the set of zero power interference measurement resources may be used for inter-cell interference (e.g., interference based on signal(s) from neighboring cell(s)) measurement. The set of non-zero power interference measurement resources may be used for multi-user multiple-input and multiple-output (MU-MIMO) interference (e.g., interference based on signal(s) transmitted to other UE(s)) measurement. The set of zero power interference prediction resources may be used for inter-cell interference prediction. The set of non-zero power interference prediction resources may be used for MU-MIMO interference prediction.

In certain aspects, the set of prediction resources may include a set of channel prediction resources and a set of interference prediction resources, and the configuration may indicate a first number of the set of channel prediction resources and a second number of the set of interference prediction resources. In some cases, the first number may be greater than the second number when a second variation in interference measurements is greater than a first variation in channel measurements. In some cases, the second number may be greater than the first number when a first variation in channel measurements is greater than a second variation in interference measurements. As described above with reference to FIG. 10, at least one of the set of measurement resources or the set of prediction resources may vary in at least one of time, frequency, or space.

In certain aspects, the configuration (which may be referred to as a resource configuration), indicating the set of resources described above, may include a set of beam configurations respectively associated with the set of resources. Each beam configuration of the set of beam configurations may include a field (e.g., a defined field), where the field may indicate whether a resource (e.g., a corresponding resource) of the set of resources is a prediction resource or a measurement resource. For example, such field may include a one-bit flag, where a first value (e.g., of “1”) may indicate that the resource is a prediction resource, and a second value (e.g., of “0”) may indicate that the resource is a measurement resource. Accordingly, the beam indicated as a prediction resource (e.g., based on a value of “1” in a defined field or a flag) may not actually be transmitted since it is a prediction beam. The beam indicated as a measurement resource (e.g., based on a value of “0” in the defined field or flag) may be transmitted. For example, network entity 1102 may transmit a reference signal using a resource (e.g., a first resource) of the set of resources, where the resource may be associated with a beam configuration of the set of beam configurations, and the field of the beam configuration may indicate that the resource associated with the beam configuration is the measurement resource.

In some cases, the field (e.g., a flag) may be associated with an information element of a resource configuration (e.g., a CSI resource configuration). For example, the field may be for non-zero power CSI-RS beam(s), where the field may be associated with a CSI-RS resource set list, a non-zero power CSI-RS SSB, a non-zero power CSI-RS resource set list, or a specific non-zero power CSI-RS resource. In other examples, the field may be for SSB beams, where the field may be associated with a CSI-RS resource set list, a non-zero power CSI-RS SSB, a CSI-SSB resource set list, or a specific SSB resource. In yet other examples, the field may be for CSI-interference measurement (IM) beam(s), where the field may be associated with a CSI-IM resource set list or a specific CSI-IM resource. In certain cases, the resource configuration may be associated with an indication or identifier included in the configuration.

At 1108, network entity 1102 receives a report including one or more SINR values, where each SINR value of the one or more SINR values may be based on a channel power component and an interference component. At least one of a channel power component or an interference component, associated with an SINR value of the one or more SINR values, may include a predicted value associated with a prediction resource of the set of prediction resources. The channel power component and the interference component (described further herein with reference to FIG. 9) may be measured or predicted in accordance with the configuration transmitted by network entity 1102 at 1106. For example, the predicted value (e.g., for the channel power component or the interference component) may be determined on the prediction resource (e.g., a channel prediction resource or an interference prediction resource).

In certain aspects, the UE 1104 may transmit report via RRC signaling, as part of a MAC-CE, or as part of a UCI.

In certain aspects, the report may include an indication that the SINR value is a predicted value. The indication may be explicit or implied. For example, the indication may be included as part of a report configuration. In certain cases, the report configuration, including such an indication and/or at least some of the information described below, may be associated with one or more identifiers or parameters included in the configuration.

In certain aspects, the SINR value may include a reported value associated with the set of prediction resources. Accordingly, the reported value may indicate (e.g., implicitly) that the SINR value is a predicted value. In some cases, the report may include or be associated with a report configuration that indicates the reported value as a predicted value based on being reported on a prediction resource (beam). For example, when resources for channel management, CSI-IM resources for interference, or non-zero power CSI-RS resources for interference in a CSI report configuration indicates a prediction resource, the reported value may be a predicted value.

In certain aspects, the report may include an indication of a SINR prediction mode. For example, the indication of the SINR prediction mode (e.g., one of the three modes described above—including a first mode based on channel prediction and interference prediction, a second mode based on channel measurement and interference prediction, and a third mode based on channel prediction and interference measurement) may be indicated in a field of a configuration, for example, using a two-bit flag. For example, a value of “01” may indicate the first mode, a value of “10” may indicate the second mode, and a value of “11” may indicate the third mode.

In certain aspects, the set of prediction resources may include a set of channel prediction resources and a set of interference prediction resources, and the SINR value may be associated with one or more of the set of channel prediction resources or the set of interference prediction resources. In certain aspects, the set of prediction resources may include a set of channel prediction resources, a set of zero power interference prediction resources, and a set of non-zero power interference prediction resources, and the SINR value may be associated with one or more of the set of channel prediction resources, the set of zero power interference prediction resources, or the set of non-zero power interference prediction resources. When UE 1104 is configured to report one or more SINR values on one or more of the prediction resources (prediction beams) described above, the SINR prediction mode may be indicated (e.g., implicitly) accordingly. For example, when resources for channel management included in a report configuration associated with the report of the one or more SINR values include a prediction resource, the corresponding SINR value may be based on a channel prediction. When CSI-IM resources for interference included in the report configuration include a prediction resource, the corresponding SINR value may be based on an inter-cell interference prediction. When non-zero power CSI-RS resources for interference included in the report configuration include a prediction resource, the corresponding SINR value may be based on a MU-MIMO interference prediction. Accordingly, the information included in the report configuration (e.g., a combination of instances of information included in the resources for channel management, the CSI-IM resources for interference, and the non-zero power CSI-RS resources described above) may indicate (e.g., implicitly) the SINR prediction mode—as one of the three modes described above.

In certain aspects, the one or more SINR values may include a respective predicted SINR value associated with each prediction resource of the set of prediction resources. In certain aspects, the one or more SINR values may include a respective predicted SINR value associated with each prediction resource of a subset of the set of prediction resources, where the subset may be associated with a number of beams (e.g., a defined number of beams). For example, the number of beams may be associated with a set of highest SINR values. In some cases, UE 1104 may also report SSB resource indicator(s) (SSBRI(s)) or CSI-RS resource indicator(s) (CRI(s)) of the number of beams associated with the set of highest SINR values. In some cases, the one or more SINR values may include a respective SINR value for each measurement resource of the set of measurement resources (or a subset of the set of measurement resources). In certain cases, the one or more SINR values may include a respective SINR value for a pair of channel and interference resources of a set of pairs of channel and interference resources.

In certain aspects, the SINR value may include a predicted value, such as a predicted SINR value (e.g., based on a predicted channel power component and/or a predicted interference component), and the report may include a confidence level associated with the predicted value. In some cases, the UE 1104 may report the confidence value(s), and the network entity 1102 may determine how to use the confidence value(s). For example, when the UE 1104 reports a predicted SINR value for a specific beam and associates it with a relatively low (e.g., lower than a threshold, such as a defined threshold) confidence level in prediction, the network entity 1102 may avoid selecting this beam for PDSCH transmission (e.g., even when this beam may be associated with a high predicted SINR value). Thus, the network entity 1102 may select this beam for PDSCH transmission, and transmit a PDSCH using this beam (or more generally, a resource), when (e.g., only when) the confidence level associated with the predicted SINR value for this beam (or more generally, a resource) meets (e.g., exceeds) a threshold. In another example, the UE 1104 may report a predicted SINR value for a specific beam when (e.g., only when) this beam is associated with a confidence level that meets a threshold.

Note that the process flow illustrated in FIG. 11 is an example of SINR prediction, and aspects of the present disclosure may be applied to SINR prediction. Note that the process flow illustrated in FIG. 11 is described herein to facilitate an understanding of SINR prediction, and aspects of the present disclosure may be performed in various manners via alternative or additional signaling and/or operations. In certain aspects, the operations and/or signaling of FIG. 11 may occur in an order different from that described or depicted, and various actions, operations, and/or signaling may be added, omitted, or combined.

### Example Operations of a Network Entity

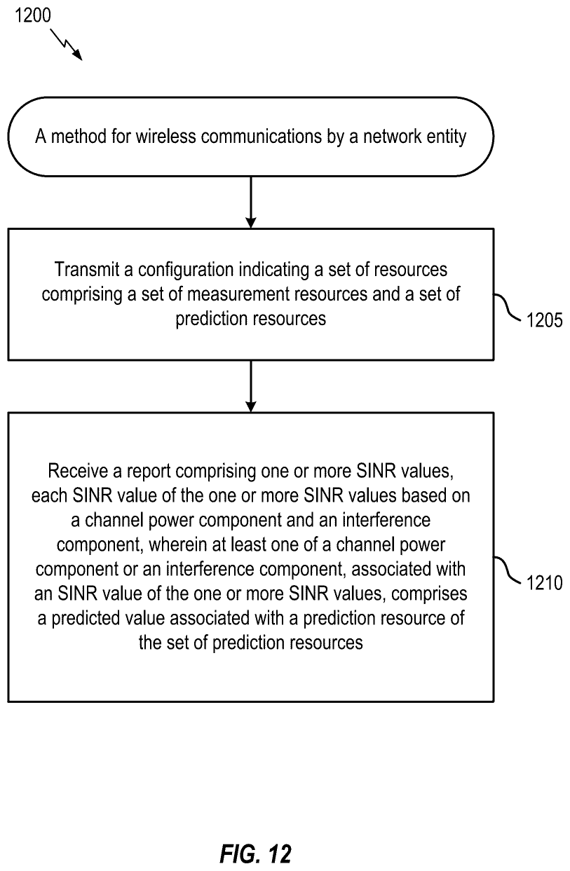

FIG. 12 shows a method 1200 for wireless communications by a network entity, such as BS 102 of FIG. 1 a first network entity 300 or second network entity 302 of FIG. 3, a disaggregated base station as discussed with respect to FIG. 2, a network entity 502 of FIG. 5, or a network entity 1102 as discussed with respect to FIG. 11.

Method 1200 begins at block 1205 with transmitting a configuration indicating a set of resources comprising a set of measurement resources and a set of prediction resources. For example, the configuration corresponds to the configuration transmitted by network entity 1102 at 1106 of the process flow 1100 described herein with reference to FIG. 11. The set of resources indicated in the configuration are described further herein with reference to FIGS. 9 and 10.

Method 1200 then proceeds to block 1210 with receiving a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources. For example, the report corresponds to the report received by network entity 1102 at 1108 of the process flow 1100 described herein with reference to FIG. 11. The predicted value described above with respect to block 1210 may be predicted by using, for example, the SINR prediction component 904, as described herein with reference to FIG. 9.

In some aspects, the set of measurement resources comprises a set of channel measurement resources and a set of interference measurement resources, and the set of prediction resources comprises at least one of a set of channel prediction resources or a set of interference prediction resources.

In some aspects, the set of interference measurement resources comprises a set of zero power interference measurement resources and a set of non-zero power interference measurement resources, and the set of interference prediction resources comprises a set of zero power interference prediction resources and a set of non-zero power interference prediction resources.

In some aspects, the set of prediction resources comprises a set of channel prediction resources and a set of interference prediction resources, and the configuration indicates a first number of the set of channel prediction resources and a second number of the set of interference prediction resources, the first number being greater than the second number when a second variation in interference measurements is greater than a first variation in channel measurements.

In some aspects, the set of prediction resources comprises a set of channel prediction resources and a set of interference prediction resources, and the configuration indicates a first number of the set of channel prediction resources and a second number of the set of interference prediction resources, the second number being greater than the first number when a first variation in channel measurements is greater than a second variation in interference measurements.

In some aspects, at least one of the set of measurement resources or the set of prediction resources varies in at least one of time, frequency, or space.

In some aspects, the configuration, indicating the set of resources, comprises a set of beam configurations respectively associated with the set of resources, each beam configuration of the set of beam configurations comprising a field, the field indicating whether a resource of the set of resources is a prediction resource or a measurement resource.

In certain aspects, method 1200 further includes transmitting a reference signal using a resource of the set of resources, the resource associated with a beam configuration of the set of beam configurations, the field of the beam configuration indicating that the resource associated with the beam configuration is the measurement resource.

In some aspects, the report comprises an indication that the SINR value is a predicted value.

In some aspects, the SINR value comprises a reported value associated with the set of prediction resources, the reported value indicating that the SINR value is a predicted value.

In some aspects, the report comprises an indication of a SINR prediction mode.

In some aspects, the set of prediction resources comprises a set of channel prediction resources and a set of interference prediction resources, and the SINR value is associated with one or more of the set of channel prediction resources or the set of interference prediction resources.

In some aspects, the set of prediction resources comprises a set of channel prediction resources, a set of zero power interference prediction resources, and a set of non-zero power interference prediction resources, and the SINR value is associated with one or more of the set of channel prediction resources, the set of zero power interference prediction resources, or the set of non-zero power interference prediction resources.

In some aspects, the one or more SINR values comprise a respective predicted SINR value associated with each prediction resource of the set of prediction resources.

In some aspects, the one or more SINR values comprise a respective predicted SINR value associated with each prediction resource of a subset of the set of prediction resources, the subset associated with a number of beams.

In some aspects, the number of beams are associated with a set of highest SINR values.

In some aspects, the SINR value comprises a predicted value, and the report comprises a confidence level associated with the predicted value.

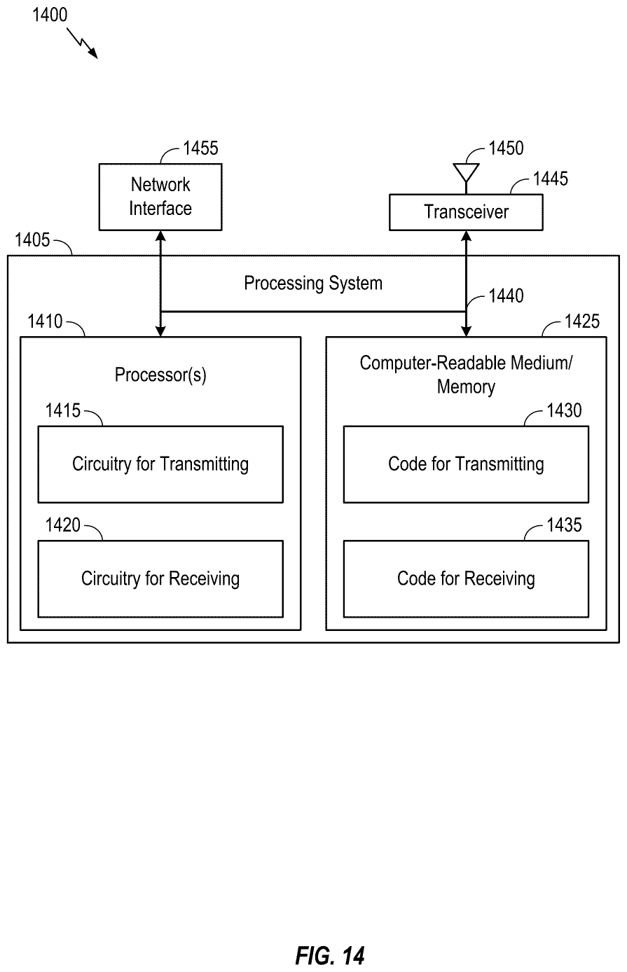

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

As described further herein, method 1200 provides the beneficial technical advantage of a flexibility to configure a UE to report one or more predicted SINRs based on channel prediction only, interference prediction only, or both channel and interference predictions. In certain cases, a prediction (e.g., a channel prediction or an interference prediction) based on more measurements (e.g., compared to when based on less measurements) may result in increased accuracy in the prediction, since the prediction would be based on more of measurement data. In certain cases, a prediction (e.g., a channel prediction or an interference prediction) based on less measurements (e.g., compared to when based on more measurements) may result in reduced reporting overhead and/or reduced power consumption, since a UE and a network entity may communicate less of measurement data.

Note that FIG. 12 is just one example of a method, and other methods including fewer, additional, or alternative operations are possible consistent with this disclosure.

### Example Operations of a User Equipment

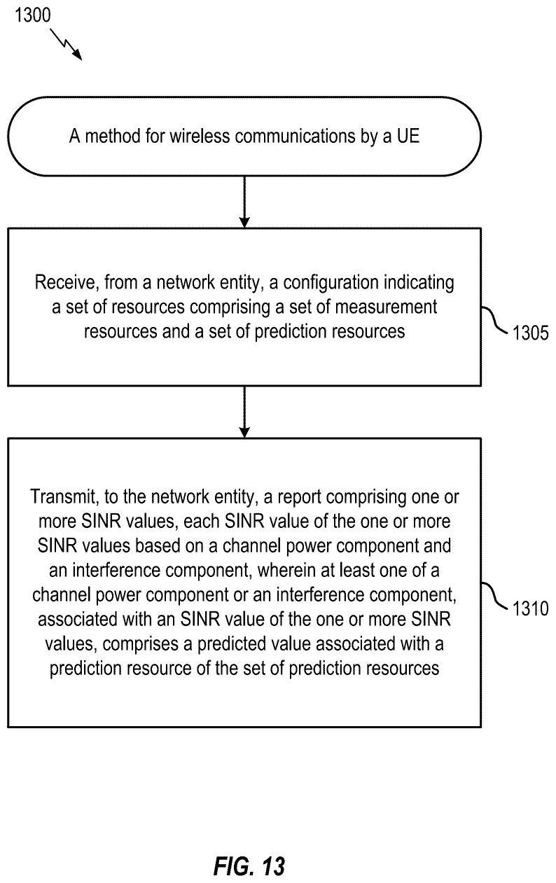

FIG. 13 shows a method 1300 for wireless communications by a UE, such as UE 104 of FIG. 1, UE 304 of FIG. 3, UE 504 of FIG. 5, or UE 1104 as discussed with respect to FIG. 11.

Method 1300 begins at block 1305 with receiving, from a network entity, a configuration indicating a set of resources comprising a set of measurement resources and a set of prediction resources. For example, the configuration corresponds to the configuration transmitted by network entity 1102 (and received by UE 1104) at 1106 of the process flow 1100 described herein with reference to FIG. 11. The set of resources indicated in the configuration are described further herein with reference to FIGS. 9 and 10.

Method 1300 then proceeds to block 1310 with transmitting, to the network entity, a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources. For example, the report corresponds to the report received by network entity 1102 (and transmitted by UE 1104) at 1108 of the process flow 1100 described herein with reference to FIG. 11. The predicted value described above with respect to block 1310 may be predicted by using, for example, the SINR prediction component 904, as described herein with reference to FIG. 9.

In some aspects, the set of measurement resources comprises a set of channel measurement resources and a set of interference measurement resources, and the set of prediction resources comprises at least one of a set of channel prediction resources or a set of interference prediction resources.

In some aspects, the set of interference measurement resources comprises a set of zero power interference measurement resources and a set of non-zero power interference measurement resources, and the set of interference prediction resources comprises a set of zero power interference prediction resources and a set of non-zero power interference prediction resources.

In some aspects, the set of prediction resources comprises a set of channel prediction resources and a set of interference prediction resources, and the configuration indicates a first number of the set of channel prediction resources and a second number of the set of interference prediction resources, the first number being greater than the second number when a second variation in interference measurements is greater than a first variation in channel measurements.

In some aspects, the set of prediction resources comprises a set of channel prediction resources and a set of interference prediction resources, and the configuration indicates a first number of the set of channel prediction resources and a second number of the set of interference prediction resources, the second number being greater than the first number when a first variation in channel measurements is greater than a second variation in interference measurements.

In some aspects, at least one of the set of measurement resources or the set of prediction resources varies in at least one of time, frequency, or space.

In some aspects, the configuration, indicating the set of resources, comprises a set of beam configurations respectively associated with the set of resources, each beam configuration of the set of beam configurations comprising a field, the field indicating whether a resource of the set of resources is a prediction resource or a measurement resource.

In some aspects, method 1300 further includes receiving a reference signal using a resource of the set of resources, the resource associated with a beam configuration of the set of beam configurations, the field of the beam configuration indicating that the resource associated with the beam configuration is the measurement resource.

In some aspects, the report comprises an indication that the SINR value is a predicted value.

In some aspects, the SINR value comprises a reported value associated with the set of prediction resources, the reported value indicating that the SINR value is a predicted value.

In some aspects, the report comprises an indication of a SINR prediction mode.

In some aspects, the set of prediction resources comprises a set of channel prediction resources and a set of interference prediction resources, and the SINR value is associated with one or more of the set of channel prediction resources or the set of interference prediction resources.

In some aspects, the set of prediction resources comprises a set of channel prediction resources, a set of zero power interference prediction resources, and a set of non-zero power interference prediction resources, and the SINR value is associated with one or more of the set of channel prediction resources, the set of zero power interference prediction resources, or the set of non-zero power interference prediction resources.

In some aspects, the one or more SINR values comprise a respective predicted SINR value associated with each prediction resource of the set of prediction resources.

In some aspects, the one or more SINR values comprise a respective predicted SINR value associated with each prediction resource of a subset of the set of prediction resources, the subset associated with a number of beams.

In some aspects, the number of beams are associated with a set of highest SINR values.

In some aspects, the SINR value comprises a predicted value, and the report comprises a confidence level associated with the predicted value.

In some aspects, method 1300 further includes predicting the SINR value using one or more AI/ML models.

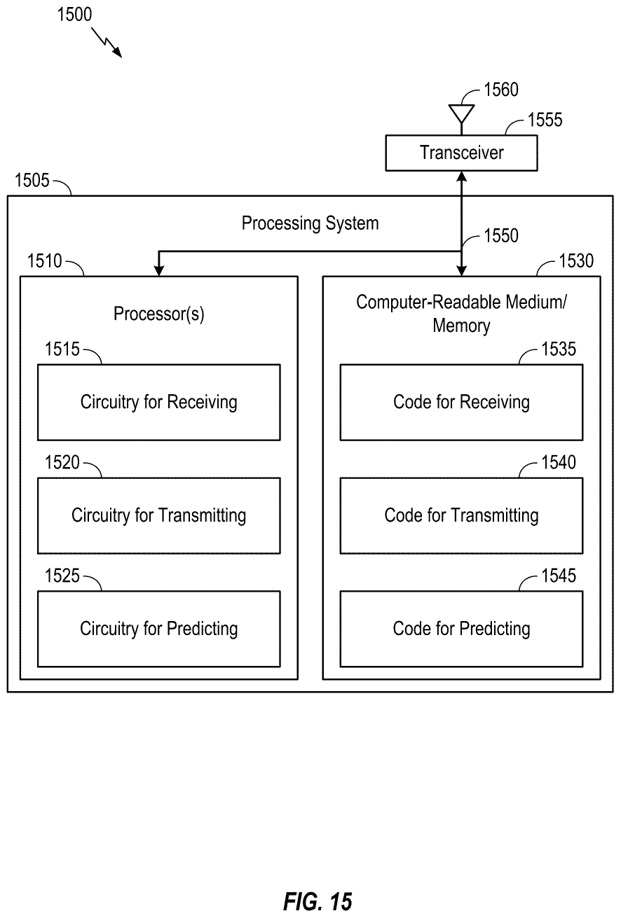

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Method 1300 may enable improved wireless communications performance, such as reduced reporting overhead and reduced power consumption (e.g., for a UE). The reduced reporting overhead and reduced power consumption may be attributable to reduced amount of SINR measurement and increased UE sleep time, for example, where the increased UE sleep time may be due to the reduced amount of SINR measurement (e.g., reduced measurement duration).

Note that FIG. 13 is just one example of a method, and other methods including fewer, additional, or alternative operations are possible consistent with this disclosure.

### Example Communication Devices

FIG. 14 depicts aspects of an example communications device configured for wireless communications. In some aspects, communications device 1400 is a network entity, such as BS 102 of FIG. 1, first network entity 300 or second network entity 302 of FIG. 3, a disaggregated base station as discussed with respect to FIG. 2, a network entity 502 of FIG. 5, or a network entity 1102 as discussed with respect to FIG. 11.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12 or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for transmitting 1430 and code for receiving 1435. Processing of the code 1430 and 1435 may enable and cause the communications device 1400 to perform the method 1200 described with respect to FIG. 12 or any aspect related to it. For instance, in some aspects, code for transmitting 1430 includes code for transmitting a configuration indicating a set of resources comprising a set of measurement resources and a set of prediction resources. In some aspects, code for receiving 1435 includes code for receiving a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

The one or more processors 1410 include circuitry configured to implement (e.g., execute) the code stored in the computer-readable medium/memory 1425, including circuitry for transmitting 1415 and circuitry for receiving 1420. Processing with circuitry 1415 and 1420 may enable and cause the communications device 1400 to perform the method 1200 described with respect to FIG. 12 or any aspect related to it. For instance, in some aspects, circuitry for transmitting 1415 includes circuitry for transmitting a configuration indicating a set of resources comprising a set of measurement resources and a set of prediction resources. In some aspects, circuitry for receiving 1420 includes circuitry for receiving a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

Various components of the communications device 1400 may provide means for performing the method 1200 described with respect to FIG. 12 or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

FIG. 15 depicts aspects of an example communications device 1500 configured for wireless communications. In some aspects, communications device 1500 is a user equipment, such as UE 104 described above with respect to FIG. 1, UE 304 described with respect to FIG. 3, UE 504 of FIG. 5, or UE 1104 as discussed with respect to FIG. 11.

The communications device 1500 includes a processing system 1505 coupled to a transceiver 1555 (e.g., a transmitter and/or a receiver). The transceiver 1555 is configured to transmit and receive signals for the communications device 1500 via an antenna 1560, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1530. In various aspects, the one or more processors 1510 may be representative of the one or more processors 318 described with respect to FIG. 3. The one or more processors 1510 are coupled to a computer-readable medium/memory 1530 via a bus 1550. In some aspects, the computer-readable medium/memory 1530 may be representative of the one or more memories 320 described with respect to FIG. 3. The computer-readable medium/memory 1530 is a non-transitory computer-readable medium/memory. In certain aspects, the computer-readable medium/memory 1530 is configured to store instructions (e.g., computer-executable code), that when executed by the one or more processors 1510, cause the one or more processors 1510 to perform the method 1300 described with respect to FIG. 13, or any aspect related to it, including any operations described in relation to FIG. 13. Note that reference to a processor performing a function of communications device 1500 may include one or more processors performing that function of communications device 1500, such as in a distributed fashion.

In the depicted example, computer-readable medium/memory 1530 stores code (e.g., executable instructions), including code for receiving 1535, code for transmitting 1540, and code for predicting 1545. Processing of the code 1535-1545 may enable and cause the communications device 1500 to perform the method 1300 described with respect to FIG. 13, or any aspect related to it. For instance, in some aspects, code for receiving 1535 includes code for receiving, from a network entity, a configuration indicating a set of resources comprising a set of measurement resources and a set of prediction resources. In some aspects, code for transmitting 1540 includes code for transmitting, to the network entity, a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

The one or more processors 1510 include circuitry configured to implement (e.g., execute) the code stored in the computer-readable medium/memory 1530, including circuitry for receiving 1515, circuitry for transmitting 1520, and circuitry for predicting 1525. Processing with circuitry 1515-1525 may enable and cause the communications device 1500 to perform the method 1300 described with respect to FIG. 13, or any aspect related to it. For instance, in some aspects, circuitry for receiving 1515 includes circuitry for receiving, from a network entity, a configuration indicating a set of resources comprising a set of measurement resources and a set of prediction resources. In some aspects, circuitry for transmitting 1520 includes circuitry for transmitting, to the network entity, a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

More generally, means for communicating, transmitting, sending or outputting for transmission may include the one or more transceivers 324, one or more antenna 322 and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1555 and/or antenna 1560 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by a network entity comprising: transmitting a configuration indicating a set of resources comprising a set of measurement resources and a set of prediction resources; and receiving a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

Clause 2: The method of Clause 1, wherein: the set of measurement resources comprises a set of channel measurement resources and a set of interference measurement resources, and the set of prediction resources comprises at least one of a set of channel prediction resources or a set of interference prediction resources.

Clause 3: The method of Clause 2, wherein: the set of interference measurement resources comprises a set of zero power interference measurement resources and a set of non-zero power interference measurement resources, and the set of interference prediction resources comprises a set of zero power interference prediction resources and a set of non-zero power interference prediction resources.

Clause 4: The method of any one of Clauses 1-3, wherein: the set of prediction resources comprises a set of channel prediction resources and a set of interference prediction resources, and the configuration indicates a first number of the set of channel prediction resources and a second number of the set of interference prediction resources, the first number being greater than the second number when a second variation in interference measurements is greater than a first variation in channel measurements.

Clause 5: The method of any one of Clauses 1-4, wherein: the set of prediction resources comprises a set of channel prediction resources and a set of interference prediction resources, and the configuration indicates a first number of the set of channel prediction resources and a second number of the set of interference prediction resources, the second number being greater than the first number when a first variation in channel measurements is greater than a second variation in interference measurements.

Clause 6: The method of any one of Clauses 1-5, wherein at least one of the set of measurement resources or the set of prediction resources varies in at least one of time, frequency, or space.

Clause 7: The method of any one of Clauses 1-6, wherein the configuration, indicating the set of resources, comprises a set of beam configurations respectively associated with the set of resources, each beam configuration of the set of beam configurations comprising a field, the field indicating whether a resource of the set of resources is a prediction resource or a measurement resource.

Clause 8: The method of Clause 7, further comprising transmitting a reference signal using a first resource of the set of resources, the first resource associated with a beam configuration of the set of beam configurations, the field of the beam configuration indicating that the first resource associated with the beam configuration is the measurement resource.

Clause 9: The method of any one of Clauses 1-8, wherein the report comprises an indication that the SINR value is a predicted value.

Clause 10: The method of any one of Clauses 1-9, wherein the SINR value comprises a reported value associated with the set of prediction resources, the reported value indicating that the SINR value is a predicted value.

Clause 11: The method of any one of Clauses 1-10, wherein the report comprises an indication of a SINR prediction mode.

Clause 12: The method of any one of Clauses 1-11, wherein: the set of prediction resources comprises a set of channel prediction resources and a set of interference prediction resources, and the SINR value is associated with one or more of the set of channel prediction resources or the set of interference prediction resources.

Clause 13: The method of any one of Clauses 1-12, wherein: the set of prediction resources comprises a set of channel prediction resources, a set of zero power interference prediction resources, and a set of non-zero power interference prediction resources, and the SINR value is associated with one or more of the set of channel prediction resources, the set of zero power interference prediction resources, or the set of non-zero power interference prediction resources.

Clause 14: The method of any one of Clauses 1-13, wherein the one or more SINR values comprise a respective predicted SINR value associated with each prediction resource of the set of prediction resources.

Clause 15: The method of any one of Clauses 1-14, wherein the one or more SINR values comprise a respective predicted SINR value associated with each prediction resource of a subset of the set of prediction resources, the subset associated with a number of beams.

Clause 16: The method of Clause 15, wherein the number of beams are associated with a set of highest SINR values.

Clause 17: The method of any one of Clauses 1-16, wherein the SINR value comprises a predicted value, and the report comprises a confidence level associated with the predicted value.

Clause 18: A method for wireless communications by a UE comprising: receiving, from a network entity, a configuration indicating a set of resources comprising a set of measurement resources and a set of prediction resources; and transmitting, to the network entity, a report comprising one or more SINR values, each SINR value of the one or more SINR values based on a channel power component and an interference component, wherein at least one of a channel power component or an interference component, associated with an SINR value of the one or more SINR values, comprises a predicted value associated with a prediction resource of the set of prediction resources.

Clause 19: The method of Clause 18, wherein: the set of measurement resources comprises a set of channel measurement resources and a set of interference measurement resources, and the set of prediction resources comprises at least one of a set of channel prediction resources or a set of interference prediction resources.

Clause 20: The method of Clause 19, wherein: the set of interference measurement resources comprises a set of zero power interference measurement resources and a set of non-zero power interference measurement resources, and the set of interference prediction resources comprises a set of zero power interference prediction resources and a set of non-zero power interference prediction resources.

Clause 21: The method of any one of Clauses 18-20, wherein: the set of prediction resources comprises a set of channel prediction resources and a set of interference prediction resources, and the configuration indicates a first number of the set of channel prediction resources and a second number of the set of interference prediction resources, the first number being greater than the second number when a second variation in interference measurements is greater than a first variation in channel measurements.

Clause 22: The method of any one of Clauses 18-21, wherein: the set of prediction resources comprises a set of channel prediction resources and a set of interference prediction resources, and the configuration indicates a first number of the set of channel prediction resources and a second number of the set of interference prediction resources, the second number being greater than the first number when a first variation in channel measurements is greater than a second variation in interference measurements.

Clause 23: The method of any one of Clauses 18-22, wherein at least one of the set of measurement resources or the set of prediction resources varies in at least one of time, frequency, or space.

Clause 24: The method of any one of Clauses 18-23, wherein the configuration, indicating the set of resources, comprises a set of beam configurations respectively associated with the set of resources, each beam configuration of the set of beam configurations comprising a field, the field indicating whether a resource of the set of resources is a prediction resource or a measurement resource.

Clause 25: The method of Clause 24, further comprising receiving a reference signal using a first resource of the set of resources, the first resource associated with a beam configuration of the set of beam configurations, the field of the beam configuration indicating that the first resource associated with the beam configuration is the measurement resource.

Clause 26: The method of any one of Clauses 18-25, wherein the report comprises an indication that the SINR value is a predicted value.

Clause 27: The method of any one of Clauses 18-26, wherein the SINR value comprises a reported value associated with the set of prediction resources, the reported value indicating that the SINR value is a predicted value.

Clause 28: The method of any one of Clauses 18-27, wherein the report comprises an indication of a SINR prediction mode.

Clause 29: The method of any one of Clauses 18-28, wherein: the set of prediction resources comprises a set of channel prediction resources and a set of interference prediction resources, and the SINR value is associated with one or more of the set of channel prediction resources or the set of interference prediction resources.

Clause 30: The method of any one of Clauses 18-29, wherein: the set of prediction resources comprises a set of channel prediction resources, a set of zero power interference prediction resources, and a set of non-zero power interference prediction resources, and the SINR value is associated with one or more of the set of channel prediction resources, the set of zero power interference prediction resources, or the set of non-zero power interference prediction resources.

Clause 31: The method of any one of Clauses 18-30, wherein the one or more SINR values comprise a respective predicted SINR value associated with each prediction resource of the set of prediction resources.

Clause 32: The method of any one of Clauses 18-31, wherein the one or more SINR values comprise a respective predicted SINR value associated with each prediction resource of a subset of the set of prediction resources, the subset associated with a number of beams.

Clause 33: The method of Clause 32, wherein the number of beams are associated with a set of highest SINR values.

Clause 34: The method of any one of Clauses 18-33, wherein the SINR value comprises a predicted value, and the report comprises a confidence level associated with the predicted value.

Clause 35: The method of any one of Clauses 18-34, further comprising predicting the SINR value using one or more AI/ML models.

Clause 36: One or more apparatuses, comprising: one or more memories comprising executable instructions; and one or more processors configured to execute the executable instructions and cause the one or more apparatuses to perform a method in accordance with any one of Clauses 1-35.

Clause 37: One or more apparatuses configured for wireless communications, comprising: one or more memories; and one or more processors, coupled to the one or more memories, configured to cause the one or more apparatuses to perform a method in accordance with any one of Clauses 1-35.

Clause 38: One or more apparatuses configured for wireless communications, comprising: one or more memories; and one or more processors, coupled to the one or more memories, configured to perform a method in accordance with any one of Clauses 1-35.

Clause 39: One or more apparatuses, comprising means for performing a method in accordance with any one of Clauses 1-35.

Clause 40: One or more non-transitory computer-readable media comprising executable instructions that, when executed by one or more processors of one or more apparatuses, cause the one or more apparatuses to perform a method in accordance with any one of Clauses 1-35.

Clause 41: One or more computer program products embodied on one or more computer-readable storage media comprising code for performing a method in accordance with any one of Clauses 1-35.

Clause 42: A user equipment (UE), comprising: a processing system that includes processor circuitry and memory circuitry that stores code and is coupled with the processor circuitry, the processing system configured to cause the UE to perform a method in accordance with any one of Clauses 18-35.

Clause 43: A network entity, comprising: a processing system that includes processor circuitry and memory circuitry that stores code and is coupled with the processor circuitry, the processing system configured to cause the network entity to perform a method in accordance with any one of Clauses 1-17.

Clause 44: One or more apparatuses configured for wireless communications, comprising: a processing system that includes one or more processors and one or more memories coupled with the one or more processors, the processing system configured to cause the one or more apparatuses to perform a method in accordance with any one of Clauses 1-35.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an A SIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a network entity to:
transmit a configuration indicating a set of resources comprising a set of measurement resources and a set of prediction resources; and
receive a report comprising one or more signal-to-noise and interference ratio (SINR) values, each SINR value of the one or more SINR values based on a channel power component and an interference component,
wherein at least one of a channel power component or an interference component, associated with an SINR value of the one or more SINR values, comprises a predicted value associated with a prediction resource of the set of prediction resources.

2. The apparatus of claim 1, wherein:
the set of measurement resources comprises a set of channel measurement resources and a set of interference measurement resources, and
the set of prediction resources comprises at least one of a set of channel prediction resources or a set of interference prediction resources.

3. The apparatus of claim 2, wherein:
the set of interference measurement resources comprises a set of zero power interference measurement resources and a set of non-zero power interference measurement resources, and
the set of interference prediction resources comprises a set of zero power interference prediction resources and a set of non-zero power interference prediction resources.

4. The apparatus of claim 1, wherein:
the set of prediction resources comprises a set of channel prediction resources and a set of interference prediction resources, and
the configuration indicates a first number of the set of channel prediction resources and a second number of the set of interference prediction resources, the first number being greater than the second number when a second variation in interference measurements is greater than a first variation in channel measurements.

5. The apparatus of claim 1, wherein:
the set of prediction resources comprises a set of channel prediction resources and a set of interference prediction resources, and
the configuration indicates a first number of the set of channel prediction resources and a second number of the set of interference prediction resources, the second number being greater than the first number when a first variation in channel measurements is greater than a second variation in interference measurements.

6. The apparatus of claim 1, wherein at least one of the set of measurement resources or the set of prediction resources varies in at least one of time, frequency, or space.

7. The apparatus of claim 1, wherein the configuration, indicating the set of resources, comprises a set of beam configurations respectively associated with the set of resources, each beam configuration of the set of beam configurations comprising a field, the field indicating whether a resource of the set of resources is a prediction resource or a measurement resource.

8. The apparatus of claim 7, wherein the processing system is further configured to cause the network entity to transmit a reference signal using a first resource of the set of resources, the first resource associated with a beam configuration of the set of beam configurations, the field of the beam configuration indicating that the first resource associated with the beam configuration is the measurement resource.

9. The apparatus of claim 1, wherein the report comprises an indication that the SINR value is a predicted value.

10. The apparatus of claim 1, wherein the SINR value comprises a reported value associated with the set of prediction resources, the reported value indicating that the SINR value is a predicted value.

11. The apparatus of claim 1, wherein the report comprises an indication of a SINR prediction mode.

12. The apparatus of claim 1, wherein:
the set of prediction resources comprises a set of channel prediction resources and a set of interference prediction resources, and
the SINR value is associated with one or more of the set of channel prediction resources or the set of interference prediction resources.

13. The apparatus of claim 1, wherein:
the set of prediction resources comprises a set of channel prediction resources, a set of zero power interference prediction resources, and a set of non-zero power interference prediction resources, and
the SINR value is associated with one or more of the set of channel prediction resources, the set of zero power interference prediction resources, or the set of non-zero power interference prediction resources.

14. The apparatus of claim 1, wherein the one or more SINR values comprise a respective predicted SINR value associated with each prediction resource of the set of prediction resources.

15. The apparatus of claim 1, wherein the one or more SINR values comprise a respective predicted SINR value associated with each prediction resource of a subset of the set of prediction resources, the subset associated with a number of beams.

16. The apparatus of claim 15, wherein the number of beams are associated with a set of highest SINR values.

17. The apparatus of claim 1, wherein the SINR value comprises a predicted SINR value, and the report comprises a confidence level associated with the predicted SINR value.

18. The apparatus of claim 17, wherein the processing system is further configured to cause the network entity to transmit a physical downlink shared channel (PDSCH) using a resource, of the set of resources, associated with the predicted SINR value when the confidence level associated with the predicted SINR value meets a threshold.

19. An apparatus for wireless communications, comprising a processing system that includes one or more processors and one or more memories coupled with the one or more processors, the processing system configured to cause a user equipment (UE) to:
receive, from a network entity, a configuration indicating a set of resources comprising a set of measurement resources and a set of prediction resources; and
transmit, to the network entity, a report comprising one or more signal-to-noise and interference ratio (SINR) values, each SINR value of the one or more SINR values based on a channel power component and an interference component,
wherein at least one of a channel power component or an interference component, associated with an SINR value of the one or more SINR values, comprises a predicted value associated with a prediction resource of the set of prediction resources.

20. A method for wireless communications by a network entity, comprising:
transmitting a configuration indicating a set of resources comprising a set of measurement resources and a set of prediction resources; and
receiving a report comprising one or more signal-to-noise and interference ratio (SINR) values, each SINR value of the one or more SINR values based on a channel power component and an interference component,
wherein at least one of a channel power component or an interference component, associated with an SINR value of the one or more SINR values, comprises a predicted value associated with a prediction resource of the set of prediction resources.
